(19) United States
(12) Patent Application Publication
(10) Pub. No.: US 2004/0188494 A1
(43) Pub. Date: Sep. 30, 2004

(54) Apparatus for installing framing material hangers

(75) Inventor: Vincent T. Kozyrski, Plainville, CT (US)

Correspondence Address: McCormick, Paulding & Huber LLP, CityPlace II, 185 Asylum Street, Hartford, CT, 06103-3402, US

(73) Assignee: The Fletcher-Terry Company, Farmington, CT

(21) Appl. No.: 10/734,837

(22) Filed: Dec. 12, 2003

Related U.S. Application Data
(60) Provisional application No. 60/459,012, filed on Mar. 31, 2003.

(51) Int. Cl. B25C 7/00

(52) U.S. Cl. 227/152; 227/154

(57) ABSTRACT

An apparatus for installing framing material hangers is provided that includes a table, a selectively operable actuator, and a magazine. The table includes a base panel. The selectively operable actuator is mounted relative to the table, such that the actuator is spaced apart from the base panel a distance. The actuator includes a piston. The magazine is operable to hold one or more hangers, the magazine having a first end positioned adjacent the actuator piston. Operating the actuator causes the piston or a member connected to the piston to contact at least one of the hangers and drive it toward the base panel.

This application claims the benefit of U.S. Provisional Application No. 60/459,012, filed 31 Mar. 2003, which is hereby incorporated by reference in its entirety.

### BACKGROUND OF THE INVENTION

1. Technical Field

The present invention relates to hangers for framing materials in general, and to apparatus and methods for installing one or more hangers into framing material in particular.

2. Background Information

Framing materials such as picture frames, artwork frames, and the like are often include one or more hangers attached to the back surface of the frame for hanging purposes. The hanger typically includes a cross member extending between a pair of posts. The posts are inserted a distance into the frame, leaving the cross member spaced apart from the frame. Presently available hangers are often inserted manually.

What is needed is a hanger and an apparatus for installing framing material hangers that permits the automation of hanger installation.

### DISCLOSURE OF THE INVENTION

According to the present invention, an apparatus for installing framing material hangers is provided that includes a table, a selectively operable actuator, and a magazine. The table includes a base panel. The selectively operable actuator is mounted relative to the table, such that the actuator is spaced apart from the base panel a distance. The actuator includes a piston. The magazine is operable to hold one or more hangers, the magazine having a first end positioned adjacent the actuator piston. Operating the actuator causes the piston or a member connected to the piston to contact at least one of the hangers and drive it toward the base panel.

According to an aspect of the present invention a stack of hangers is provided. The individual hangers within the stack are attached to one another by tabs, or other means for attaching adjacent hangers.

According to another aspect of the present invention, a portable hand tool is provided having an actuator and a magazine similar to that described above.

These and other objects, features, and advantages of the present invention will become apparent in light of the detailed description of the present invention.

### BRIEF DESCRIPTION OF THE DRAWINGS

FIG. 1 is a diagrammatic, partially sectioned, side view of an embodiment of the present apparatus for installing framing material hangers. The sectioned portion of FIG. 1 is cut along a line depicted as A-A in FIG. 5.

FIG. 2 is a diagrammatic top view of an embodiment of the present apparatus, including a magazine that extends fore and aft.

FIG. 3 is a diagrammatic top view of an embodiment of the present apparatus, including a magazine that extends laterally.

FIG. 4 is a diagrammatic side view of the table base panel and a side panel.

FIG. 5 is a diagrammatic, partially sectioned, top view of an embodiment of a magazine and head assembly.

FIG. 6 is a diagrammatic top view of a present invention hanger.

FIG. 7 is a diagrammatic front view of the hanger shown in FIG. 6.

FIG. 8 is a diagrammatic end view of the hanger shown in FIG. 6.

FIG. 9 is an end view of a stack of the present invention hangers.

FIG. 10 is a top view of the stack of the hangers shown in FIG. 9.

### DETAILED DESCRIPTION OF THE INVENTION

An apparatus 20 for installing one or more hangers 22 into a framing material 24 is described herein that encompasses numerous embodiments, including the preferred embodiment described below. The apparatus includes a table 26, a selectively operable actuator 28, and a magazine 30.

The table 26 includes a base panel 32 having an upper surface 34 that is typically planar. Some embodiments of the table 26 further include one or more back panels 36 and/or side panels 38, as will be described below. In some embodiments, gradations (e.g., along an x-axis or y-axis) are visible on the base panel 32 for locating framing material 24 relative to the actuator 28.

In those embodiments that include a back panel 36, the back panel 36 is either fixed or is selectively positionable relative to the base panel 32. The back panel 36 typically has a cross-sectional geometry that extends away from the base panel 32, approximately perpendicular to the base panel 32. The cross-sectional geometry of the back panel 36 alternatively can be contoured to match the cross-sectional geometry of the frame material 24. The back panel 36 can extend straight, parallel to the edge of the base panel 32, or can extend along an arcuate path (or other non-straight path) to accommodate a frame material shape. For example, the back panel 36 can extend along an oval or elliptical path to facilitate mating with an oval or elliptical shaped frame material. The back panel 36 may include gradations (e.g., x-axis) to facilitate positioning of the frame material 24 relative to the actuator 28.

In those embodiments that include a side panel 38, the side panel 38 may be fixed or selectively positionable relative to the base panel 32. The side panel 38 typically has a cross-sectional geometry that extends away from, and is approximately perpendicular to, the base panel 32. The cross-sectional geometry of the side panel 38 can also be contoured to match the cross-sectional geometry of the frame material 24. The side panel 38 can extend straight or can extend along an arcuate path (or other non-straight path) to accommodate a frame material shape. The side panel 38 may include gradations (e.g., y-axis) to facilitate positioning of the frame material 24 relative to the actuator 28.

In some embodiments, one or more positional stops 40 may be used to provide a physical reference point against which frame material 24 can be positioned. The physical stops 40 may, for example, be attached to one or more of the base panel 32, back panel 36, and side panel 38. The positional stops 40 may be used in place of, or in addition to, the back panel 36 and/or side panel 38. One or more of the base panel 32, back panel 36, and side panel 38 may include predetermined locations for mounting the positional stops 40; e.g., that correspond to predetermined frame material dimensions.

The selectively operable actuator 28 includes a piston 42 having a stroke. The length of the piston stroke may be chosen to accommodate an actuator 28 that is positionally adjustable relative to the base panel 32 (or vice versa), or to accommodate an actuator 28 that is positionally fixed relative to the base panel 32. The preferred actuator 28 is a pneumatic cylinder having a piston 42 that is extendable by at least the aforesaid stroke. Movement of the piston 42 is controlled by a controller 44 to cause the actuator 28 to insert a hanger 22 into the framing material 24 in a desired predetermined manner; e.g., until a predetermined depth is reached, until a predetermined amount of force is reached, etc. Controllers (solenoid valves, etc.) capable of controlling an actuator such as a pneumatic cylinder and known and are commercially available. The amount of force generated by the actuator 28 can be tailored to suit the application at hand. A switch 46 is used to signal the controller 44. A variety of switches 46 can be used, including foot pedal or hand-operated type switches. In some embodiments, the switch 46 is a plunger type switch mounted in the back panel 36.

The actuator 28 is mounted relative to the table 26 by attachment to an actuator support member 48. The actuator 28 is spaced apart from the base a distance (i.e., along a z-axis) to permit framing material 24 to be disposed between the actuator 28 and the base panel 32 of the table 26. In some embodiments, one or both of the actuator 28 and the base panel 32 is selectively positionable relative to the other to accommodate different frame material thicknesses (i.e., to change relative positions along the z-axis). In some embodiments, the actuator 28 is selectively positionable relative to the base panel 32 to accommodate different frame material member widths; e.g., the actuator 28 is selectively positionable along a line extending fore and aft, parallel to the base panel 32 (i.e., along a y-axis).

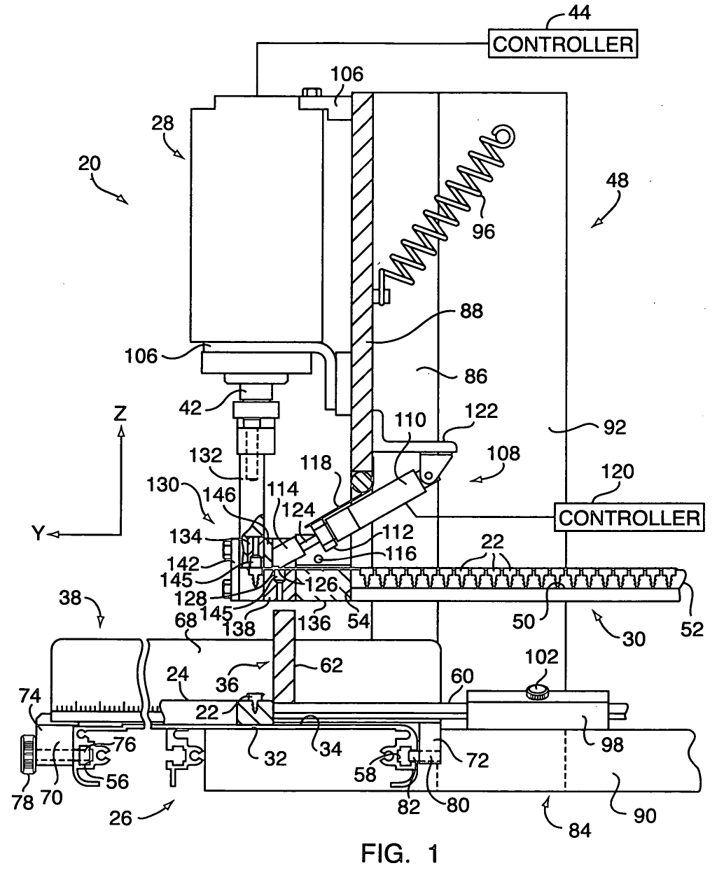

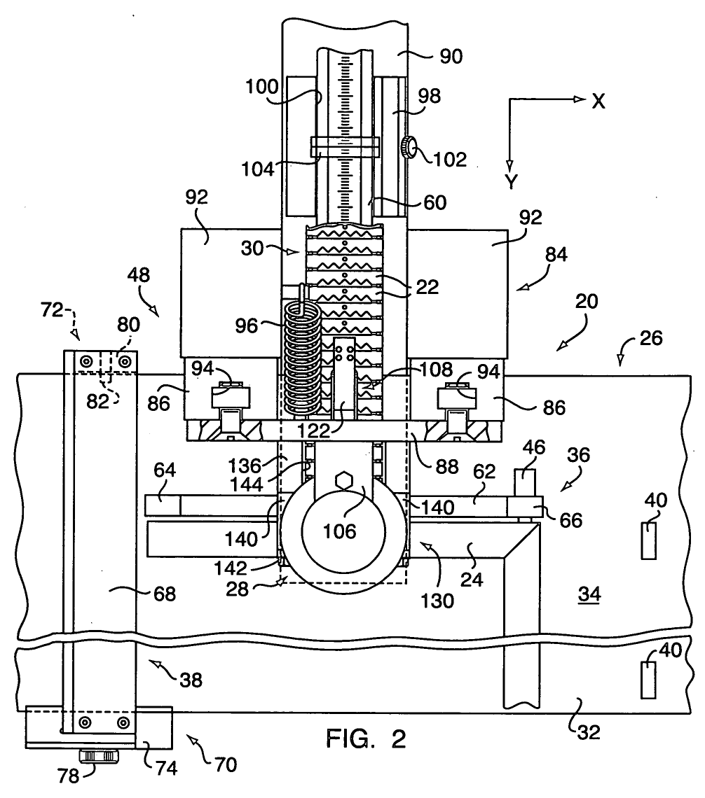

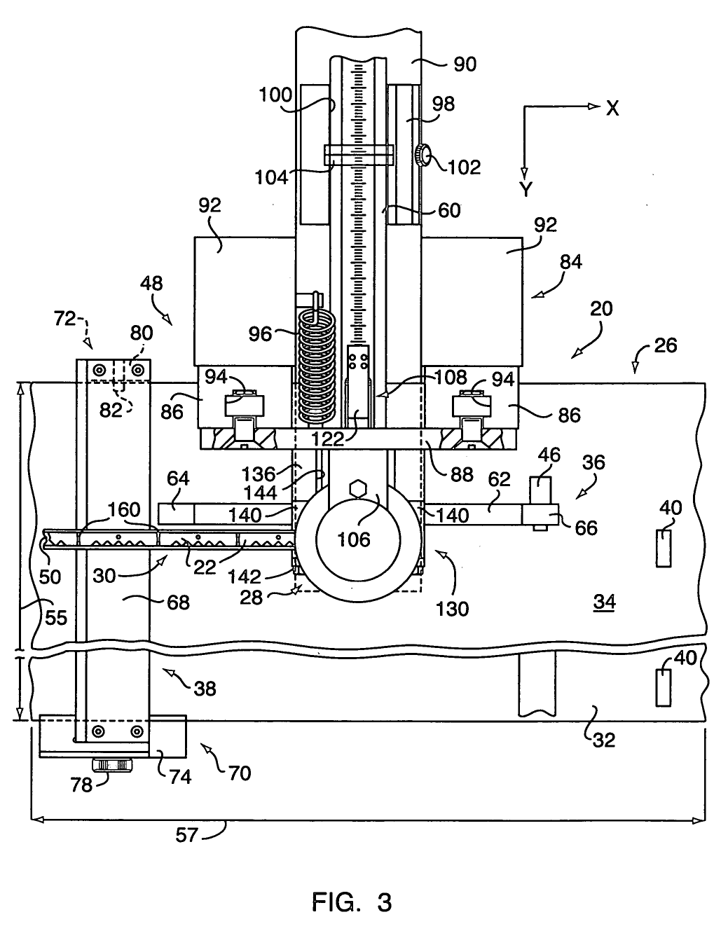

The magazine 30 includes a channel 50, a fill end 52, and an actuator end 54. The channel 50 is sized to hold a plurality of the hangers 22. The cross-sectional geometry of the channel 50 is chosen to mate with the geometry of the hanger used, and the orientation of the hanger within the channel 50. For example, a channel 50 can have a cross-sectional geometry to receive hangers 22 disposed back to back (e.g., see FIGS. 1 and 2), or a cross-sectional geometry to receive hangers 22 disposed side to side (e.g., see FIG. 3). In some embodiments, the magazine 30 includes a biasing element for biasing the hangers 22 within the channel 50 toward the actuator end 54 of the magazine 30. A coil spring that acts against the hangers 22 within the channel 50 is an example of a biasing element.

The magazine 30 may be positioned such that the actuator end 54 is adjacent the actuator 28 and the magazine 30 is disposed along a line that extends fore and aft (i.e., along the y-axis, as shown in FIGS. 1 and 2). In alternative embodiments, the magazine 30 may be positioned such that the actuator end 54 is adjacent the actuator 28 and the magazine 30 is positioned along a laterally extending line; (i.e., along the x-axis, as shown in FIG. 3). In both of these embodiments, the magazine 30 is positioned relative to the piston 42 of the selectively operable actuator 28 to enable hangers 22 to travel to a position where they can be aligned with the piston (or a member attached thereto).

A preferred embodiment of the present invention is shown in FIGS. 1-5. Referring now to FIGS. 1, 2, and 4 the table 26 includes a base panel 32, a back panel 36, and a side panel 38. The base panel 32 includes a width 55, a length 57, a front channel 56, and a back channel 58. The front and back channels 56,58 extend along the lengthwise edges of the base panel 32. The upper surface 34 of the base panel 32 may include gradations (e.g., a scale denoting inches and portions thereof extending widthwise and lengthwise along the base panel 32.

Referring to FIGS. 2 and 3, the back panel 36 includes a guide rail 60, a cross member 62, a first side post 64, and a second side post 66. The first side post 64 is attached to one end of the cross member 62 and the second side post 66 attaches to the other end of the cross member 62. A switch 46, described below, is attached to the second side post 66. The guide rail 60 attaches to the cross member 62 between the two side posts 64,66, and extends outwardly in a direction substantially perpendicular to the cross member 62. The guide rail 60 includes gradations; e.g., a scale denoting inches and portions thereof.

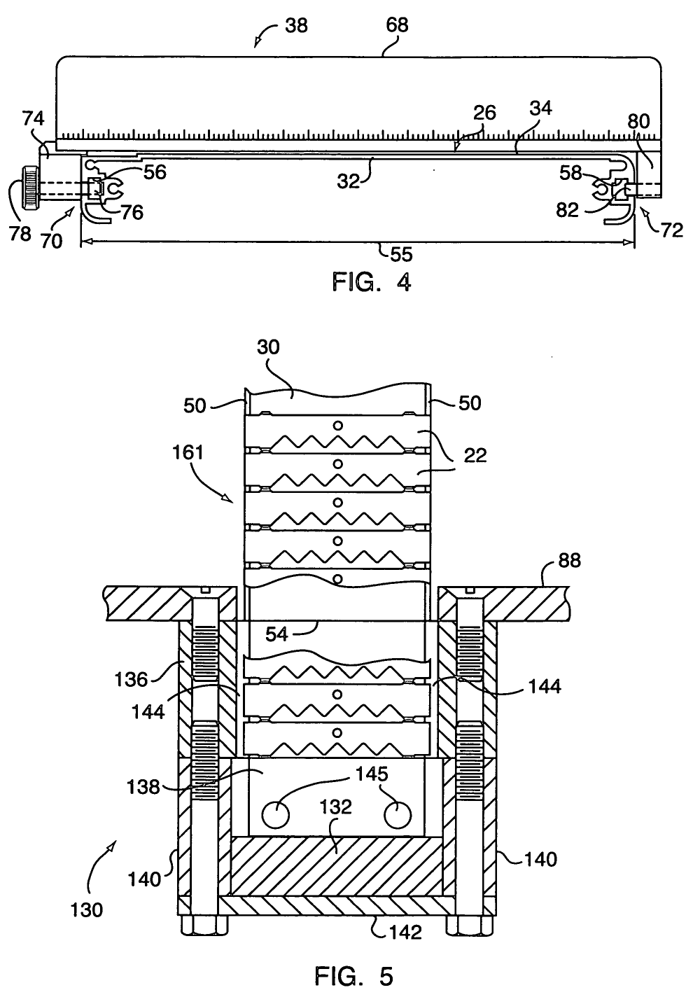

Referring to FIG. 4, the side panel 38 includes a fence 68, a front attachment assembly 70, and a back attachment assembly 72. The fence 68 extends lengthwise along the width of the base panel 32; i.e., along the Y-axis. The front attachment assembly 70 includes an outer block 74, a channel block 76, and a thumbwheel screw 78. The outer block 74 includes an aperture for receiving the thumbscrew 78 and the channel block 76 is threaded for engagement with a threaded portion of the thumbwheel screw 78. The rear attachment assembly 72 includes an outer block 80 having a pin 82.

Referring to FIGS. 1 and 2, the actuator support member 48 includes a frame 84, a pair of support rails 86, and a back plate 88. The frame 84 includes a base member 90 attached to, and extending between, a pair of parallel pillars 92. The base portion of the table 26 attaches to a forward portion of the base member 90, in such a manner that the table 26 is substantially perpendicular to the pillars 92. One of the support rails 86 is attached to the forward surface of each pillar 92. The support rails 86 each have a channel 94 that extending along the length of the support rail 86. The back plate 88 is attached to the support rails 86 in a manner that permits it to be moved up and down relative to the base panel 32 of the table 26, and selectively fixed at a plurality of positions. A spring 96 extends between the back plate 88 and the frame 84. The spring 96 exerts an upward force on the back plate 88 to offset a portion of the weight of the back plate 88 and actuator 28 attached thereto as will be described below.

A guide block 98 is attached to an aft portion of the base member 90. The guide block 98 includes a channel 100, a thumbscrew 102, and a transparent member 104 marked with one or more gradations. The cross-section of the channel 100 mates with the cross-section of the guide rail 60 of the back panel 36. A slide fit between guide block channel 100 and the guide rail 60 permits the rail 60 to be moved back and forth relative to the guide block 98. The thumbscrew 102 is operable to secure the guide rail 60 within the channel 100. The transparent member 104 is disposed in a position where it can be used with the gradations on the guide rail 60 to determine relative position therebetween. The gradations on the guide rail 60 and the transparent member 104 are preferably calibrated to denote the position of the back panel 36 relative to the actuator 28 as will be discussed below.

The actuator 28 is attached to the back plate 88 by a pair of brackets 106. The actuator 28 is positioned such that the piston stroke travels vertically (i.e., along a z-axis) under normal operating conditions. The actuator 28 is a pneumatic cylinder that has a piston 42 that is extendable a predetermined stroke. The pneumatic cylinder 28 and the controllers 44 (solenoid valves, etc.) that control it are known and commercially available. The switch 46 used to signal the controller 44 is a plunger type switch mounted in the second side post 66 of the back panel 36 (see FIG. 2).

The magazine 30 includes a channel 50, a fill end 52, and an actuator end 54. The cross-sectional geometry of the channel 50, the orientation of the magazine 30 relative to the actuator 28 (i.e., extending along the y-axis), and the length of the magazine 30 permits a stack of hangers 22, arranged back-to-back, to be disposed on top of the channel 50.

Referring to FIG. 1, in the preferred embodiment the apparatus 20 further includes a hanger feed mechanism 108 that includes a selectively operable feed actuator 110, a spring block 112, a pawl 114, a guide 116, and a biasing member 118. The feed actuator 110 is a pneumatic cylinder having a piston that is controlled by a feed actuator controller 120 (e.g., a pneumatic valve). Pneumatic cylinders and controllers capable of controlling an actuator such as a pneumatic cylinder and known and are commercially available. The feed actuator 110 is pivotally mounted to a bracket 122, which is, in turn, attached to the back plate 88. The spring block 112 is attached to the feed actuator. The pawl 114, which is attached to the feed actuator piston 124, includes one or more tabs 126 extending out from a contact face 128. The biasing member 118 is attached to the back plate 88 and biases the feed actuator 110 toward the magazine 30. The guide 116 maintains the pawl 114 in a desired position when the actuator 110 is retracted.

Referring to FIGS. 1 and 5, the preferred embodiment of the apparatus 20 further includes a head assembly 130 that includes a plunger 132, a plunger shear block 134, an intermediate channel member 136, a stationary shear block 138, a pair of spacers 140, and a front plate 142. The plunger shear block 134 and plunger 132 are attached to one another, and the plunger 132 is attached to the piston 42 of the actuator 28. The intermediate channel member 136 is attached to the back plate 88, and has a guide portion 144 that has a cross-section that is similar to the cross-section of the magazine channel 50. The stationary shear block 138 is attached to the opposite surface of the intermediate channel member 136, and also has a cross-section that mates with the hangers 22. The stationary shear block 138 and the plunger shear block 134 both preferably include magnets 145 to facilitate positioning of hangers 22 within the head assembly 130. The spacers 140 are disposed between the intermediate channel member 136 and the front plate 142. The spacers 140 are spaced laterally apart from one another an amount that permits the plunger 132 to fit lengthwise therebetween. The spacers 140 separate the front plate 142 and the stationary shear block 138 apart from one another an amount that permits the plunger 132 to fit widthwise therebetween. Collectively, the spacers 140, the front plate 142, and the stationary shear block 138 create a passage to receive the plunger 132. In those embodiments that include a hanger feed mechanism 108, the head assembly 130 further includes a pawl stop 146.

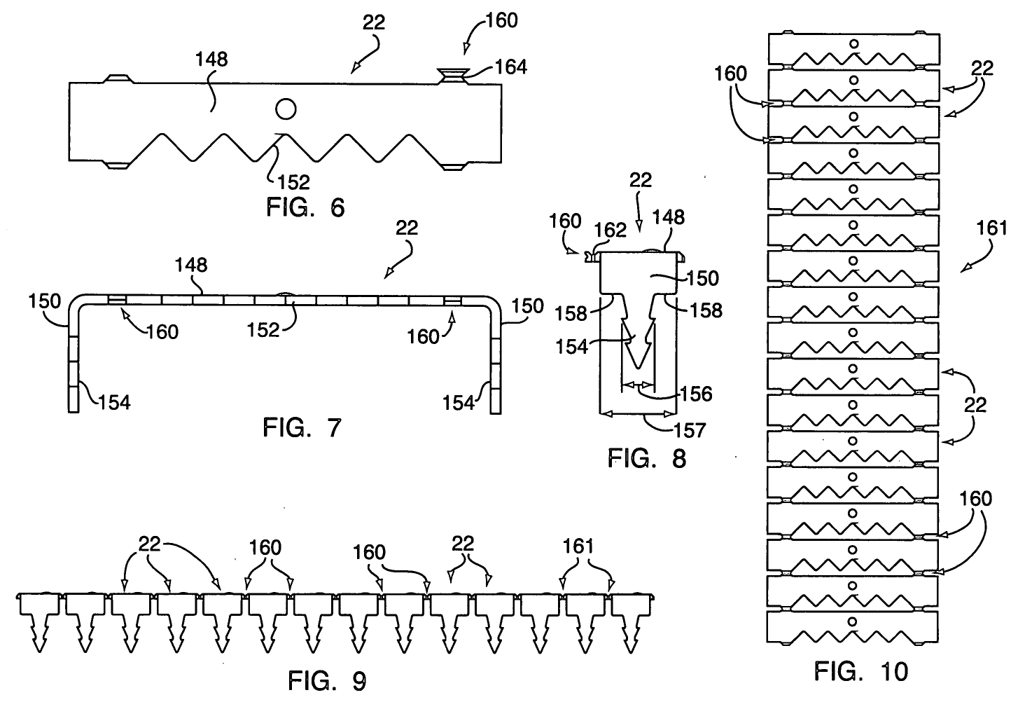

Referring to FIGS. 6-10, the various embodiments of the present apparatus 20 can be used with a variety of different hangers 22. In most instances, each hanger 22 has a web 148 that extends between a pair of legs 150 that are oriented substantially perpendicular to the web 150. The embodiment shown in FIGS. 6 and 9 also includes a plurality of indentations 152 disposed in the web 148. In the embodiment shown in FIGS. 6-10, a barbed member 154 having a “fir-tree” type configuration extends out from each leg 150, generally coplanar with the leg 150. The tip of each barbed member 150 is pointed to facilitate insertion into, and retention within, the framing material 24. The width 156 of the barbed member 154 is less than the width 157 of the leg 150 from which it extends. The difference in width creates a pair of shoulders 158 on each leg 150.

The present apparatus 20 can be used with individual hangers 22 loaded into the magazine 30, or it can be used with a stack 161 of hangers 22 joined to one another. In a preferred embodiment, adjacent hangers 22 within a stack 161 are joined together by one or more tabs 160 extending between the adjacent hangers 22. The tabs 160 are configured to be readily sheared during operation of the apparatus 20 as will described below. The tabs 160 may have features that make it is easier for them to be sheared. For example, the tabs 160 shown in FIGS. 6 and 8 have a slot 162 (see FIG. 8) that decreases the thickness of the tab 160, and a narrowed portion 164 (see FIG. 6) that decreases the width of the tab 160. The hangers 22 within a stack 161 can alternatively be attached to one another by means other than a tab; e.g., glue, tape, etc., although the aforesaid tabs 160 obviate the need to add glue, tape, etc. to join the hangers 22. The orientation of the hangers 22 within the stack is chosen to agree with the cross-sectional geometry of the magazine 30. For example, the hangers 22 within the stack 161 shown in FIGS. 9 and 10 are orientated such that the webs 148 of adjacent hangers 22 are substantially parallel and spaced apart from one another. The magazine 30 shown in FIGS. 1 and 2 is configured to receive such a stack. In an alternative embodiment, the hangers 22 within the stack 161 shown in FIG. 3 are orientated such that the legs 150 of the hangers 22 within the stack are substantially aligned along a single line. The magazine 30 shown in FIG. 3 is configured to receive such a stack.

In the operation of the apparatus 20 for installing framing material hangers 22, the actuator 28 is positioned a predetermined distance from the base panel 32 of the table 26. Depending upon the configuration of the apparatus 20, that distance is either adjusted to reflect the thickness of the farming material 24 currently being used, or is chosen to accommodate a variety of framing material thicknesses (i.e., a distance great enough to accommodate the thickest framing material anticipated). As stated above, the distance between the actuator 28 and the base panel 32 may be established by moving one or both of the base panel 32 and actuator 28.

A plurality of single hangers 22, or a stack of hangers 22, is loaded into the magazine 30. In those embodiments that include a biasing means, the biasing means biases the hangers 22 loaded within the magazine 30 toward the actuator end of the magazine 30.

To install a hanger 22 into a piece of framing material 24, the framing material 24 is placed on the base panel 32 and inserted between the actuator 28 and the base panel 32. The framing material 24 is positioned relative to the actuator 28 to insure that the hanger 22 is installed at the desired position within the framing material 24. In those embodiments that include gradations marked within the base panel 32, the user can locate the framing material 24 relative to the actuator 28 using the gradations. In those embodiments that include a back panel 36, the back panel 36 is attached to the base panel 32 and spaced apart from the actuator 28. As stated above, preferably one or both of the actuator 28 and back panel 36 are selectively positionable along a fore and aft extending line, parallel to the base panel 32 (e.g., y-axis). In such a case, the back panel 36 and actuator 28 are relatively separated by a distance that corresponds to the distance between the outer edge of the framing material 24 and the position at where the installation of the hanger 22 is desired. Using the back panel 36 obviates the need to locate the framing material 24 relative to the actuator 28; e.g., by gradations on the base panel 32. Instead, the back panel 36 can be located relative to the base panel 32. Either way, once the back panel 36 is positioned and secured to the base panel 32, a plurality of framing material pieces can be processed by placing the framing material 24 in contact with the back panel 36.

Likewise in those embodiments that include a side panel 38, the side panel 38 is attached to the base panel 32 and spaced apart from the actuator 28. Preferably one or both of the actuator 28 and side panel 38 are selectively positionable along a laterally extending line, parallel to the base panel 32 (e.g., x-axis). In such a case, the back panel 36 and actuator 28 are relatively separated by a distance that corresponds to the distance between the outer edge of the framing material member and the position at where the installation of the hanger 22 is desired. Using the side panel 38 obviates the need to locate the framing material 24 relative to actuator 28; e.g., by gradations on the base panel 32. Instead, the side panel 38 can be located relative to the base panel 32. Either way, once the side panel 38 is positioned and secured to the base panel 32, a plurality of framing material pieces can be processed by placing the framing material in contact with the side panel 38.

As stated above, positional stops can be attached to the base panel 32 in combination with the back panel 36 and/or side panel 38, or in place thereof.

Once the framing material 24 is in the desired position, the actuator controller 44 can be switched (e.g., by foot pedal, hand-operated switch, etc.) by the operator to cause a hanger 22 to be installed within the framing material. In a preferred embodiment, the switch 46 is disposed within the back panel 36. When a piece of framing material 24 is inserted between the base panel 32 and the actuator 28 and moved toward the back panel 36, the material 24 contacts and depresses the switch 46 plunger and back panel 36 causing the controller 44 to be switched.

Once the controller 44 is switched, the controller 44 causes the piston 42 of the selectively operable actuator 28 and the attached plunger 132 to extend outwardly and into contact with a hanger 22. The piston drives the hanger 22 out of the head assembly 130. If the hanger 22 is part of a stack 161 of hangers 22, the process of driving the hanger 22 out of the head assembly 130 causes the hanger 22 to separate from the stack 161. If the stack 161 comprises a plurality of hangers 22 attached to one another by tabs 160, as described above, the force of the actuator 28 causes the one or more tabs 160 to shear, thereby separating the hanger 22 from the stack 161. The actuator 28 subsequently drives the hanger 22 into the framing material 24 disposed between the base panel 32 and the actuator 28.

The amount the hanger 22 is driven into the framing material 24 can be determined by the amount of force applied by the actuator 28, or by the distance of the piston stroke. In the case of the hanger 22 having a pair of legs 150 with barbed members 152, for example, an amount of force (or distance) is preferably chosen that enables the barbed members 152 to be completely inserted into the framing material 24 and the shoulders 158 of each leg 150 into contact with the framing material 24. In that position, the web 148 is spaced apart from the framing material 24 by an amount substantially equal to the length of the legs 150.

Once the hanger 22 is driven into the framing material, the controller 44 causes the piston 42 to retract within the actuator 28. After the piston 42 is retracted to its original position, the hangers 22 within the magazine 30 are moved forward so that the next hanger 22 is aligned with the plunger 132. Movement of the hangers 22 within the magazine 30 may be accomplished by a biasing element. Alternatively, movement of the hangers 22 within the magazine 30 may be accomplished by the hanger feed mechanism 108. In that case, after a hanger 22 is installed and the actuator piston 42 is fully retracted, the feed actuator 110 is actuated by the feed actuator controller 120. The tabs 126 attached to the pawl 114, which extend into the space between a pair of adjacent hangers 22 within the stack 161, engage the more forward of the adjacent hangers 22 and drive the stack 161 within the magazine 30 toward the actuator end 54 of the magazine 30. Once the hanger stack 161 is driven an amount sufficient to place another hanger 22 into alignment with the plunger 132, the feed actuator controller 120 retracts the feed actuator 110. The magnets 145 disposed in the stationary shear block 138 facilitate maintaining the hangers 22 in the appropriate position. In the preferred embodiment, the pawl stop 146 portion of the head assembly 130 is positioned to stop the pawl 114 attached to the feed actuator 110 in a predetermined position to facilitate accurate positioning of the next-in-line hanger 22 relative to the plunger 132.

The biasing mechanism 118 maintains the pawl 114 in contact with the hanger stack as the feed actuator 110 is retracting. When the next space between hangers 22 is encountered, the tabs 126 of the pawl 114 drop into that space. The feed actuator 110 is then positioned to repeat the described feed process.

Although this invention has been shown and described with respect to the detailed embodiments thereof, it will be understood by those skilled in the art that various changes in form and detail thereof may be made without departing from the spirit and scope of the invention. For example, aspects of the above-described apparatus 20 can be incorporated into a portable hand tool version. The portable hand tool version includes an actuator 28 and a magazine 30. The actuator 28 and magazine 30 are similar to those described above.

What is claimed is:

1. An apparatus for installing framing material hangers, comprising:
a table having a base panel;
a selectively operable actuator mounted relative to the table, the actuator including a piston, wherein the actuator is spaced apart from the base panel a distance;
a magazine operable to receive one or more hangers, the magazine having a first end positioned adjacent the piston of the actuator; and
wherein operating the actuator causes the piston or a member connected to the piston to contact at least one of the hangers and drive it toward the base panel.

2. The apparatus of claim 1, wherein the actuator is selectively positionable relative to the base panel.

3. The apparatus of claim 2, wherein the actuator is selectively positionable along two axes relative to the base panel

4. The apparatus of claim 2, wherein the actuator is selectively positionable to increase or decrease the distance between the actuator and the base panel.

5. The apparatus of claim 2, wherein the base panel includes gradations indicating position on the base panel relative to the actuator.

6. The apparatus of claim 2, wherein the table further includes a back panel connected to the base panel.

7. The apparatus of claim 6, wherein the back panel is selectively positionable relative to the base panel.

8. The apparatus of claim 2, wherein the table further includes a side panel connected to the base panel.

9. The apparatus of claim 8, wherein the side panel is selectively positionable relative to the base panel.

10. The apparatus of claim 9, wherein the side panel includes gradations indicating position on the side panel relative to the actuator.

11. The apparatus of claim 1, further including one or more positional stops that are selectively attachable to the base panel.

12. The apparatus of claim 1, wherein the base panel is selectively positionable relative to the actuator.

13. The apparatus of claim 1, further comprising a switch operable to cause the selectively operable actuator to operate.

14. The apparatus of claim 13, wherein the table further includes a back panel connected to the base panel, and the switch is mounted on the back panel.

15. The apparatus of claim 14, wherein the switch is positioned relative to the actuator so that the switch can be operated by contact with framing material disposed between the base panel and the actuator.

16. The apparatus of claim 1, wherein the magazine has a channel with a cross-sectional geometry that mates with geometry of the hangers.

17. The apparatus of claim 1, wherein the magazine extends laterally outwardly from the first end.

18. The apparatus of claim 17, wherein the hangers each have a pair of legs and a web disposed between the legs, an the magazine is configured to receive hangers in a manner such that legs of the hangers are substantially aligned along a single line.

19. The apparatus of claim 1, wherein the magazine extends aft from the first end.

20. The apparatus of claim 19, wherein the hangers each have a pair of legs and a web disposed between the legs, and the magazine is configured to receive hangers such that the webs of adjacent hangers are substantially parallel and spaced apart from each other.

21. The apparatus of claim 1 wherein the magazine is operable to receive a stack of hangers connected to one another.

22. The apparatus of claim 21, wherein the stack of hangers is connected to one another by tabs, wherein operation of the actuator causes the tabs connecting the hanger being driven by the actuator to the stack to be sheared.

23. The apparatus of claim 1, further comprising a head assembly disposed between adjacent the first end of the magazine and the actuator.

24. The apparatus of claim 1, further comprising a hanger feed mechanism.

25. The apparatus of claim 24, wherein the hanger feed mechanism comprises a selectively operable feed actuator, a pawl attached to the feed actuator, and a biasing member;
wherein the feed actuator is operable to move hangers within the channel of the magazine.

26. A stack of hangers for framing material, comprising:
a plurality of hangers, each having a web extending between a pair of legs, and a barbed member extending out from each leg; and
one or more shearable tabs extending between, and attaching, adjacent ones of the plurality of hangers.

27. The stack of hangers of claim 26, wherein each leg has a shoulder surface.

28. The stack of hangers of claim 27, wherein an opening is disposed between adjacent hangers within the stack.

29. The stack of hangers of claim 26, wherein the tabs each have a feature that facilitates shearing of the tab.

30. The stack of hangers of claim 26, wherein the hangers are oriented within the stack such that legs of the hangers within the stack are substantially aligned along a single line.

31. The stack of hangers of claim 26, wherein the hangers are oriented such that the webs of adjacent hangers within the stack are substantially parallel and spaced apart from each other.

32. An apparatus for installing framing material hangers, comprising:
a handle;
a selectively operable actuator mounted relative to the handle, the actuator including a piston;
a magazine operable to hold one or more hangers, the magazine having a first end positioned adjacent the piston of the actuator; and
wherein operating the actuator causes the piston or a member connected to the piston to contact and drive at least one of the hangers.

33. The apparatus of claim 32, further comprising a switch operable to cause the selectively operable actuator to operate.

34. The apparatus of claim 33, wherein the magazine has a channel with a cross-sectional geometry that mates with a geometry of the hangers.

35. The apparatus of claim 34, wherein the magazine further includes a biasing element for biasing hangers disposed within the channel toward the first end.

36. The apparatus of claim 35, wherein the magazine is configured to receive hangers, each hanger having a pair of legs and a web disposed between the legs, in such a manner that the webs of adjacent hangers are substantially parallel and spaced apart from each other.
